(19) United States
(12) Patent Application Publication
(10) Pub. No.: US 2017/0316770 A1
(43) Pub. Date: Nov. 2, 2017

(54) ELECTROACOUSTIC BOUZOUKI WITH PERFORATED VESSEL

(71) Applicant: Athanasios PALAVRATZIS, Thessaloniki (GR)

(72) Inventor: Athanasios PALAVRATZIS, Thessaloniki (GR)

(21) Appl. No.: 15/526,468

(22) PCT Filed: Oct. 21, 2015
(86) PCT No.: PCT/GR2015/000051

§ 371 Date: May 12, 2017

(30) Foreign Application Priority Data
Nov. 27, 2014 (GR) 20140100607

(51) Int. Cl. G10H 3/18; G10D 1/00; H04R 1/02

(52) U.S. Cl. CPC G10H 3/18; H04R 1/028; G10D 1/00; H04R 2201/028

(57) ABSTRACT

Electroacoustic bouzouki with perforated vessel, for exercise as well as for concerts having a neck (1) which reaches until tailpiece (2), head (3), tuning keys for fastening strings (4), electromagnet (5) and bridge (6) on the front part (7) over which the strings pass (4), preamplifier (9) and amplifier (10) in its body, output (12), electric signal and battery (16), bearing, a rear part called vessel (13). The vessel carries on its surface at least one user-defined opening of any shape and is mounted on the front part (7) of the body by gluing or screwing. The best use of the electroacoustic bouzouki with perforated vessel takes place when the number of openings ranges from 2 to 6.

The invention belongs in the technical field of stringed musical instruments and particularly constitutes stringed electroacoustic bouzouki.

Specifically, in the present state of the art on the one hand there is the classic bouzouki which produces full natural sound and on the other hand there is the soundless bouzouki (silent instrument) which carries musical strings but because of the construction of the instrument, the vibrations of the strings are not transferred to the vessel of the instrument so reverberation is not created. The only sound that the silent instrument produces is the sound produced from the vibration of the stretched string. To the silent bouzouki the vessel is abolished, as it happens to the most electrical instruments.

Both these types of bouzouki, that is both classic acoustic bouzouki and the soundless (silent) bouzouki, present the problem of volume when the user tries to study: while the classic bouzouki produces very loud and full sound which often creates police regulations infringement problems (quiet hours), at the same time the soundless bouzouki creates the opposite technical problem i.e. that the sound produced by this is not sufficient with the result that the user cannot develop his performing virtuosity if he does not hear any natural sound. For this reason the soundless bouzouki requires the use of headphones by the user. Also its operation requires the mandatory use of electricity.

But while the soundless bouzouki solves the problem of volume when practicing, at the same time practicing of the user in a soundless bouzouki creates two additional problems: firstly the performer does not hear natural sound so he cannot perfect his acoustic and performing virtuosity—and secondly exercise in soundless bouzouki requires very little muscle power by the performer, so when the same performer attempts to execute in classic natural sound bouzouki the track exercised to perform in soundless bouzouki, he needs to practice again, in order to learn to exercise to the natural sound bouzouki the muscle strength required for the execution of that piece.

The present invention in principle solves the problem of the physical sound intensity of the two above systems (either very strong natural sound or very low natural sound), but also solves the two additional problems encountered in practicing the soundless bouzouki as aforesaid.

In a brief disclosure of the present invention, it consists in a classic in shape bouzouki, which on the one hand it produces electric sound since it bears preamplifier or/and amplifier, it bears either piezoelectric or magnet (pickup), or a combination of both and loudspeakers while on the other hand it produces natural sound since it bears perforated resonator (vessel) on the back, preferably of plastic material, while the front part may bears some openings, or not.

The existence of openings in the vessel (rear) of the instrument according to the diameter and quantity required by the order of each user, depending on his requirements, in order for the instrument to produce the desired volume, constitute the present invention which is an electroacoustic bouzouki with controlled intensity of the generated sound by its construction. The use of removable lids, which close the openings, further amplifies the produced natural sound.

The present invention, which constitutes a bouzouki operated with electricity as well as only acoustically without electricity, produces both natural sound and electric sound (unlike the prior state of the art) and also the performer exercising on this instrument maximizes his performing virtuosity as it has natural sound and as it is well known, the improvement requires the performer to receive natural sound.

There are many examples of applying the present inventive idea, however, in none of these examples the invention can produce neither the complete sound of the natural classic bouzouki nor the sound of a soundless bouzouki.

Following the above the advantages of the present invention in relation with the current state of the art is that it combines the use of electricity or without, combines piezoelectric or magnet (pickup) and generates electric sound and that physical sound, required by each performer in order to study or to perform a composition in public. At the same time, unlike other electrical installments, the present invention maintains the vessel of the instrument, providing the performer the steady holding of the instrument that the classic acoustic bouzouki offers.

The drawings accompanying the invention illustrate the following, in brief:

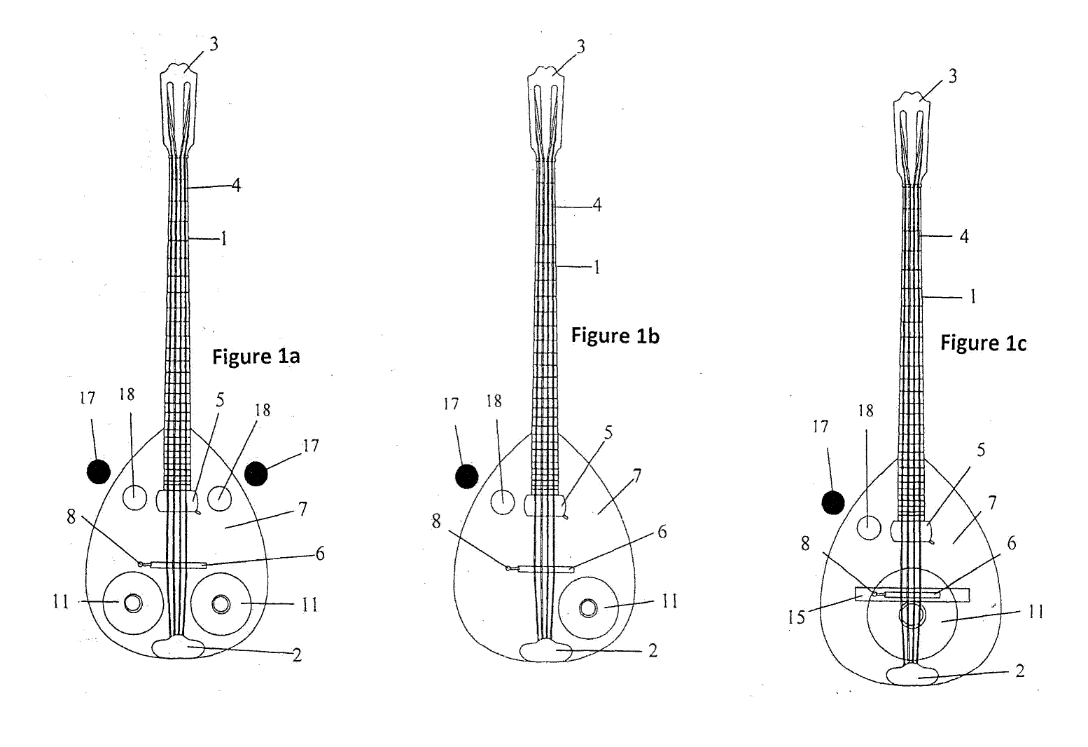

Drawing 1 illustrates the present inventive idea by the front view, with two loudspeakers and two openings as well as the detachable covers of the openings (FIG. 1a). It also illustrates a variation of the present inventive idea by the front view, with one loudspeaker and one opening as well as one removable cover of the opening (FIG. 1b). It also illustrates a variation of the present inventive idea shown in FIG. 1b, with one loudspeaker, which is positioned in the center of the front view and one opening and the removable cover of the opening, with special bridge securing the bridge of the strings (FIG. 1c).

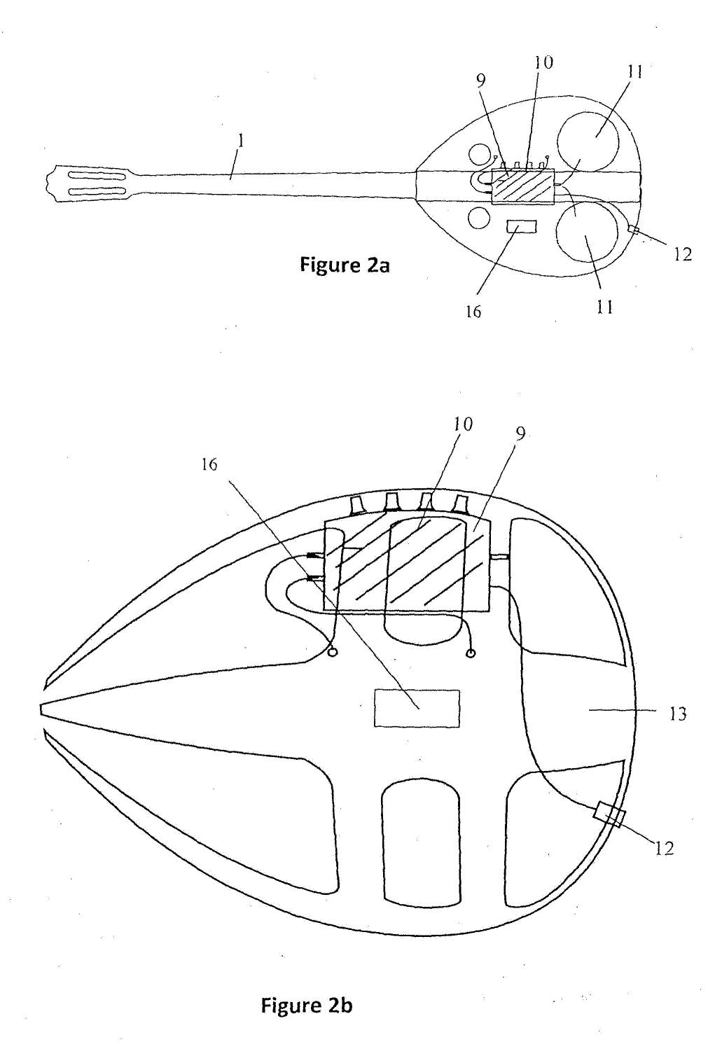

Drawing 2 illustrates the interior of the invention and its electrical components, namely, the loudspeakers, the preamplifier with amplifier without the “vessel” (back cover) of the instrument and the output to the console (FIG. 2a). Illustrates even the above-mentioned parts with the “vessel” of the instrument when the preamplifier with amplifier are placed in an alternative position to the side of the vessel, always in such a way in order for the user to have access to the setting buttons (FIG. 2b).

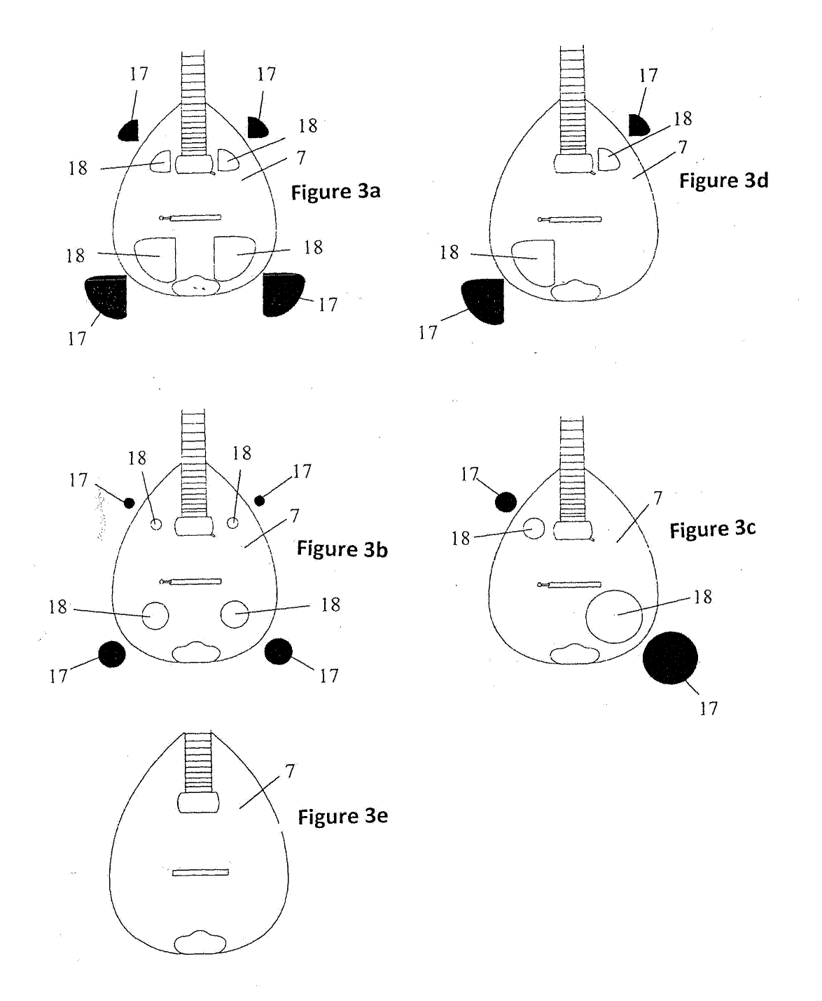

Drawing 3 illustrates the front view of the invention, in variations without loudspeaker, with small openings and removable covers (FIG. 3a), with smaller openings (FIG. 3b) or less openings (FIGS. 3c and 3d) and removable covers and without any openings (3e).

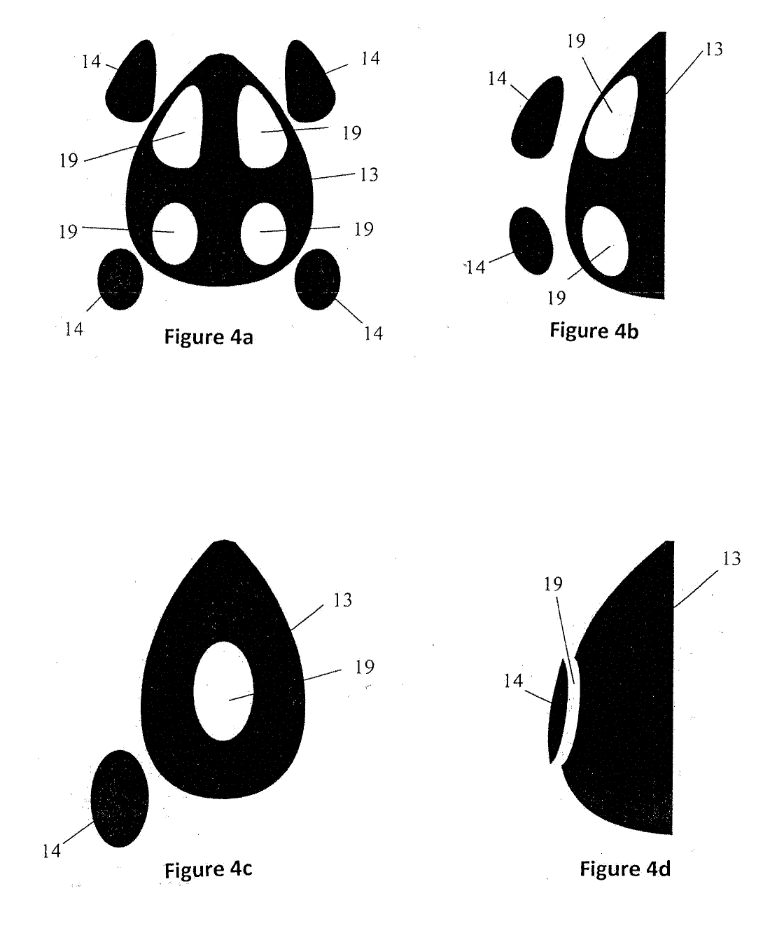

Drawing 4 illustrates the back view of the “vessel” of the invention in variations with four openings and the removable covers in plan view (FIG. 4a) and side view (FIG. 4b) and with one opening and with the removable cover in plan view (FIG. 4c) and side view (FIG. 4d).

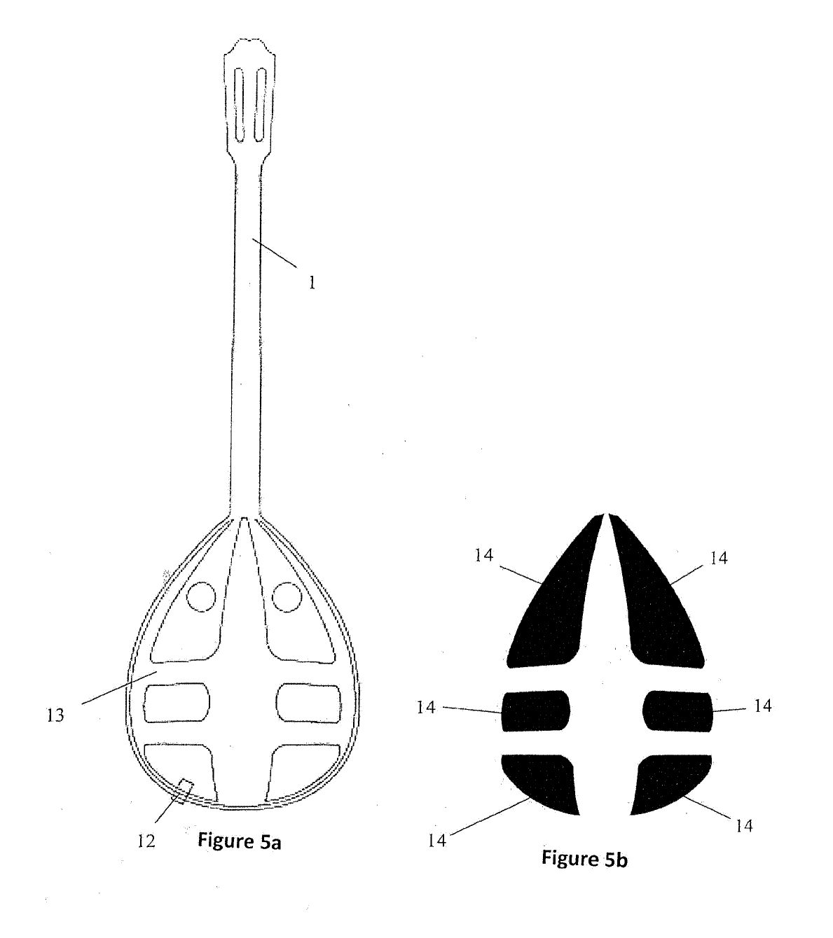

Drawing 5 illustrates in plan view the back of the “vessel” of the invention in variant with more openings (FIG. 5a) and the removable covers (FIG. 5b).

Following there is an example of an application of the present invention referring to the accompanying drawings:

As illustrated in drawings 1 and 2, the electroacoustic bouzouki, like all corresponding instruments of current state of the art, bears, in principle, neck (1), which as it happens in all electrical instruments (electric guitar, electric oud, etc.) reaches the tailpiece (2). The neck (1) on the end bears head (3) with tuning keys which tighten and secure the strings (4), carries electromagnet (5) (pickup) and bridge (6) over which the strings pass (4) and continue and fix in the tailpiece (2).

Besides all the above components, which as stated above exist in all bouzouki, the electroacoustic bouzouki further bears piezoelectric component (8) on the front (7) and mounted inside the bridge (6), for generating and shaping the electrical sound (FIGS. 1a, 1b, 1c). In the inside (FIG. 2) the electroacoustic bouzouki bears preamplifier (9) and amplifier (10) and at least one loudspeaker (11) with exit to the front view (7) of the instrument (FIG. 1b), as it can bear two loudspeakers placed symmetrically (FIG. 1a) or more loudspeakers. When the front view (7) has a loudspeaker (11) in the center (FIG. 1c), special mounting bridge (15) is used for supporting the bridge (6) which supports the strings (4), (FIGS. 1,2).

The loudspeaker (11) may be of high or low intensity at the option of the user, because placing it on the instrument intends to offer the user natural familiarity with the sound of a loudspeaker, without the need of using a separate amplifier or microphone installation.

To be able to connect to microphones, electroacoustic bouzouki also bears output (12) of electrical signal to the console. Finally it bears battery (16) for the power supply, which may be in the interior of the instrument (FIG. 2b) or can be externally and the instrument simply has a socket for connection to the battery.

Also, through the openings (13) of the vessel the user has access to the preamplifier (9) and amplifier (10) and regulates them by the available buttons (Drawing 2 FIG. 2b).

The electroacoustic bouzouki may not bring any loudspeaker in his body. Thus, as illustrated in Drawing 3, the front view (7) of the instrument, may have openings (18), small (FIG. 3a), smaller (FIG. 3b) or fewer (FIGS. 3c and 3d), in all cases with removable covers (17), or may not have any opening (FIGS. 3d). The size of the openings (18) and their number determine the intensity and configuration of the produced natural sound. In case the electroacoustic bouzouki bears no loudspeaker in its body, the existence of a preamplifier (9) is optional, mainly for reasons of cost, and the output of electric sound, for the microphone system is done either with the function of the electromagnet (5), or the piezoelectric component (8) disposed on the saddle (6) or by the combined operation of the two components.

In case of operation out of an electric network and without battery (16), the electroacoustic bouzouki always produces a natural sound, which is indeed lower in intensity of the natural sound produced by the traditional bouzouki, but is always greater than the sound produced by a soundless bouzouki. This is because if the instrument has openings in the front view (7), these are always of small size (Drawings 1 and 3) and arrive to be zero (FIG. 3e).

Drawings 4 and 5 illustrate the rear part “vessel” (13) of the invention, which in each case has at least one opening of any shape. In the examples of the inventive idea illustrated in Drawings 4 and 5 openings (19) are one opening (19) (FIGS. 4c and 4d), four openings (19) (FIGS. 4a and 4b) and six openings (19) (FIGS. 5a and 5b). For each opening there is removable cover (14) of corresponding shape.

The same inventive concept can be applied when the “vessel” of the electroacoustic bouzouki carries less or more openings, symmetrically or not, and of any shape. The removable covers of the openings adapt the instrument to the needs of each user, meaning that the addition of the covers and the closing of the openings leads to the production of stronger natural sound by the instrument, whereas the removing of the covers leads to the production of weaker natural sound.

The vessel (13) is mounted on the front part (7) of the instrument by screwing or gluing. The vessel (13) is preferably made of plastic material, but can also be of wood or light metal (e.g. aluminum). The covers (14) of the vessel (13) are preferably made of plastic material.

The covers (17) of the openings (18) of the front part (7) are preferably made of plastic material but they can also be made of any other material (e.g. wood, light metal, etc.). All covers (17) (14), of the front part (17) and vessel (13) (14) may bear decorative elements and serve as decoration of the instrument.

The perforated vessel (13), which is preferably made of plastic, keeps the shape of the vessel of the traditional wooden vessel while the openings do not affect the stability of the instrument regarding the grip and the handling by the musician. The maximum operational use of electroacoustic bouzouki with perforated vessel (13) is achieved when the vessel (13) has between four to six openings (19), as illustrated in FIGS. 4a and 5a.

The piezoelectric (8) component for the producing of the electric sound can operate alone or in conjunction with the electromagnet (5), and the electromagnet (5) can operate without the amplifier (10) and the preamplifier (9).

The present invention finds application as a musical instrument, which is used to perform music compositions both with natural, and electric sound.

1. Electroacoustic bouzouki with perforated vessel with a neck (1) reaching until tailpiece (2), head (3), tuning keys for fastening strings (4), electromagnet (5) and bridge (6) at the front part (7) over which the strings (4) pass, preamplifier (9) and amplifier inside the body, output (12) of electric signal and battery (16), characterized by the fact that its rear part called “vessel” (13), is made of any plastic material, carries on its surface at least one opening (19) of any shape and is mounted on the front part (7) of the body by gluing or screwing.

2. Electroacoustic bouzouki with perforated vessel according to claim 1, wherein the fact that the vessel (13) is made of wood or light metal.

3. Electroacoustic bouzouki with perforated vessel according to claim 1 the fact that each opening (19) of the vessel (13) has an equivalent removable cover (14) made of plastic material.

4. Electroacoustic bouzouki with perforated vessel according to claim 1, wherein the fact that the maximum utility of the invention is shown when the number of openings (19) of the vessel (13) is two to six.

5. Electroacoustic bouzouki with perforated vessel according to claim 1, wherein the fact that it bears on the front view (7) at least one loudspeaker (11).

6. Electroacoustic bouzouki with perforated vessel according to claim 1, wherein the fact that when the loudspeaker (11) is positioned to have output in the center of the front view (7) of the instrument, special mounting bridge is used (15) to place the bridge (6) that supports the strings (4).

7. Electroacoustic bouzouki with perforated vessel according to claim 1, wherein the fact that the front view
(7) of the instrument bears openings (18) of varying numbers and shapes and corresponding removable covers (17) with decorative patterns, made of plastic, wood or light metal.

8. Electroacoustic bouzouki with perforated vessel according to claim 1, wherein the fact that the front view (7) of the instrument bears openings (18) of varying numbers and shapes and corresponding removable covers (17) with decorative patterns, made of plastic, wood or light metal, and at least one loudspeaker (11).

9. Electroacoustic bouzouki with perforated vessel according to claim 1, wherein the fact that the front view (7) of the instrument does not have any opening (18) nor loudspeaker (11), the preamplifier (9) can be replaced either by the piezoelectric component (8), disposed on the bridge (6), or by electromagnet (5), or by the combined operation of both components.

10. Electroacoustic bouzouki with perforated vessel according to claim 1, wherein the fact that the production of the electric signal is achieved by adjusting the piezoelectric component (8) in the bridge (6).
